(19) United States
(12) Patent Application Publication
(10) Pub. No.: US 2010/0195843 A1
(43) Pub. Date: Aug. 5, 2010

(54) SILENCER WITH FAN AND SILENCING METHOD USING THE SAME

(75) Inventor: Masahiko HIRATA, Oita (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/695,239

(22) Filed: Jan. 28, 2010

(30) Foreign Application Priority Data
Jan. 30, 2009 (JP) 2009-019161

(51) Int. Cl. G10K 11/16

(52) U.S. Cl. 381/71.8

(57) ABSTRACT

A silencer includes a cooling fan unit that cools a component which gives off heat during operation by blowing wind to the component and that outputs signal including rotational frequency information and information about timing of initiation of one cycle of noise; a storage section that stores an opposite phase waveform for the noise given off by the cooling fan unit; and a control section that detects the signal from the cooling fan unit and that adjusts the timing of initiation of one cycle of the opposite phase waveform. The configuration obviates a necessity for a microphone used for previously storing an opposite phase waveform and complicate arithmetic processing, and hence a phase lag in the opposite phase waveform can be prevented. Accordingly, the speaker can be disposed in proximity to the cooling fan. An opposite phase waveform output from the speaker can eliminate noise given off by the cooling fan over a wide range. Further, an opposite phase waveform for only the cooling fan is previously stored, and hence the silencer is not affected by noise other than the noise given off by the cooling fan.

### BACKGROUND

1. Field of the Invention

The present invention relates to a silencer that silences unwanted sounds or noisy sounds originated from a cooling fan provided in; for instance a notebook personal computer, as well as to an electronic device using the same.

2. Description of the Related Art

In relation to electronic equipment, such as a notebook personal computer, speedup of a clock frequency of a CPU is recently proceeding. Since a quantity of heat given off by a CPU increases along with a speedup of the clock frequency, enhancement of cooling power of a cooling fan mounted in the housing is sought. Meanwhile, miniaturization of the notebook personal computer proceeds, and a space given for a cooling module is restricted. Accordingly, a quantity of air is increased by increasing the number of rotations of a cooling fan; however, this raises another problem of sounds stemming from rotation of the cooling fan causing noise. A hitherto known method for solving the problem is to employ an active noise cancellation technique (hereinafter referred to as an “ANC technique”) of eliminating a noise by emitting sound having an opposite phase and the same amplitude to the noise (JP-A-2002-244667).

However, the related-art ANC technique has the following drawbacks. First, a time lag arises in arithmetic processing in a routine including converting a noise signal (an analogue signal) collected by a microphone into a digital signal, subjecting the digital signal to signal processing, reversely converting the digital signal into an analogue signal, and outputting sound from a speaker. As a result, when a signal that is in opposite phase with the noise signal (hereinafter called an “opposite phase waveform”) is output, the phase of the output signal significantly lags behind the phase of the original sound. In order to adjust the phase delay, a large distance between the cooling fan and the speaker must be assured such that processed sound travels faster than a sound speed. However, since a distance of the order of tens of centimeters is usually required, the ANC technique is not suitable for compact electronic equipment like a notebook personal computer. As the distance between the cooling fan and the speaker becomes greater, a range where noise stemming from the cooling fan and the opposite phase waveform output from the speaker are heard canceling each other becomes narrower. Namely, the noise of the cooling fan and the opposite phase waveform intensify each other in other areas, so that an operator's position is limited. Moreover, a structural increase is entailed, which in turn adds to cost.

Further, the microphone picks up noise other than the noise originated from the cooling fan, which makes a change in the distance between a noise source and the microphone, to thus induce a phase shift. Conversely, there may be the case where noise will be output.

### SUMMARY

The present invention has been conceived in view of the problems and aims at providing a silencer that does not cause a phase lag in an opposite phase waveform and that is not affected by noise other than noise of a cooling fan, as well as providing an electronic device using the silencer.

Another object of the present invention is to provide a silencer that obviates a necessity for a microphone used for previously storing an opposite phase waveform; that can prevent occurrence of a phase lag in opposite phase waveform; that can eliminate noise given off by a cooling fan over a wide range by means of an opposite phase waveform output from a speaker; and that is not affected by noise other than the noise given off by the cooling fan.

Still another object of the present invention is to prevent occurrence of a phase lag in opposite phase waveform without a necessity for complicate arithmetic processing even when noise and an opposite phase waveform differ from each other in terms of a frequency, thereby eliminating noise.

Yet another object of the present invention is to prevent occurrence of a phase lag in opposite phase waveform without a necessity for complicate arithmetic processing even when noise and an opposite phase waveform differ from each other in terms of an amplitude, thereby eliminating noise.

Still another object of the present invention is to perform adjustment such that amplitudes become equal to each other by means of simple processing even when the amplitude of noise and the amplitude of an opposite phase waveform differ from each other, thereby preventing occurrence of a phase lag in the opposite phase waveform without requiring complicate arithmetic processing and eliminating noise.

Another object of the present invention is to readily adjust timing of initiation of one cycle of an opposite phase waveform so as to become equal to timing of initiation of one cycle of noise given off by a cooling fan unit even if an operator is situated at a location where noise cannot be eliminated well.

Still another object of the invention is to readily adjust timing of initiation of one cycle of an opposite phase waveform so as to become equal to timing of initiation of one cycle of noise given off by a cooling fan unit when an operator is situated at a location where noise cannot be eliminated well even if the timing of initiation of one cycle of the opposite phase waveform cannot be adjusted for reasons of the operator being in operation.

### BRIEF DESCRIPTION OF THE DRAWINGS

FIG. 1 is a perspective view of a centrifugal fan of an embodiment;

FIG. 2 is a perspective view of the centrifugal fan of the embodiment from which a fan cover is removed;

FIG. 3 is a hard block diagram of an electronic device equipped with a silencer of the embodiment;

FIG. 4 is a flowchart showing operation of a CPU of the embodiment;

FIG. 5 is a graph showing a correlation between an amplitude and a rotational frequency of noise of the centrifugal fan of the embodiment;

FIG. 6A is a graph showing example noise of the cooling fan;

FIG. 6B is a graph showing an opposite phase waveform for the noise shown in FIG. 6A;

FIG. 7A is a graph showing noise achieved when the number of rotations of the centrifugal fan is larger than that shown in FIG. 6A;

FIG. 7B is a graph showing an opposite phase waveform for the noise shown in FIG. 7A;

FIGS. 8A and 8B are conceptual renderings showing a relationship between noise and positions of an enclosure and an operator; and

FIGS. 9A and 9B are waveform charts showing noise heard by the operator.

### DETAILED DESCRIPTION

An embodiment of the present invention is hereunder described by reference to the drawings.

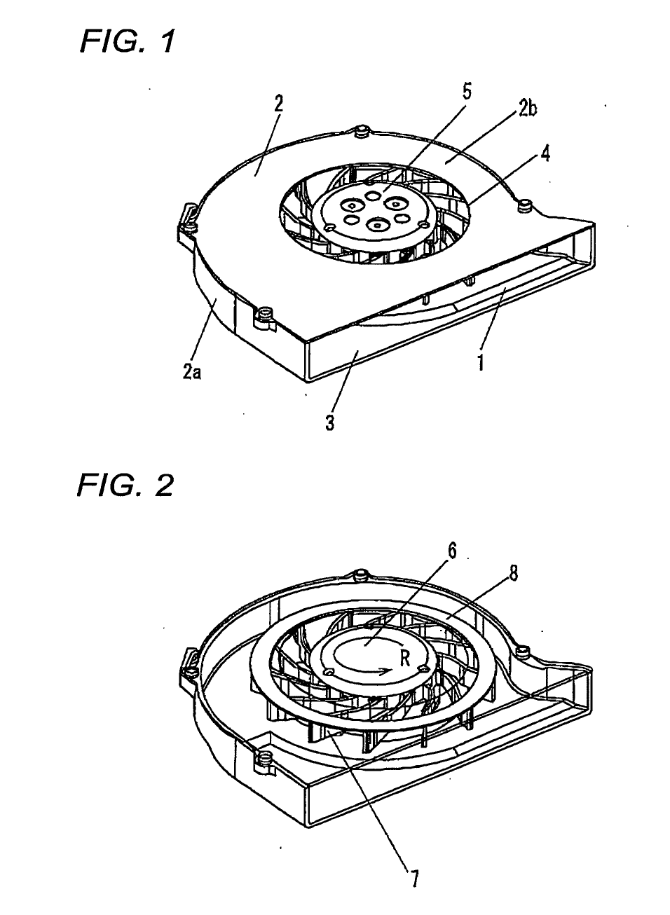

FIG. 1 is a perspective view of a centrifugal fan of an embodiment. A box-shaped fan case 2 of the centrifugal fan unit 1 is made up of a fan frame 2a located in a lower portion of the fan and a fan cover 2b situated above the fan frame. In the fan frame 2a, a bottom surface and side surfaces are integrally formed by means of resin molding or formed from an aluminum alloy by means of die-casting. An air outlet 3 for letting intake air exit is formed in one side surface, and an un-illustrated air inlet is formed in the bottom surface of the fan frame. The fan cover 2b is formed from a metallic material, such as aluminum and stainless steel, into the shape of a plate by means of punching and resin molding. A substantially circular air inlet 4 for taking in air is provided in the center of the fan cover.

The centrifugal fan 5 is arranged so as to be accommodated and sandwiched between the fan frame 2a and the fan cover 2b.

FIG. 2 is a perspective view of the centrifugal fan of the embodiment from which the fan cover is removed. In FIG. 2, the centrifugal fan 5 is made up of a hub 6 having a cylindrical periphery and a plurality of blades 7 extending from the periphery in a centrifugal direction and in a substantially radial pattern.

In relation to a predetermined area of a surface (a pressure surface) of the blade 7 visible from a rotating direction, a surface geometry of the predetermined area visible from the direction of a rotary shaft is that upper and lower edges of the blade 7 tilt toward the rotating direction than does the center of the blade 7. An upper annular plate 8 is provided along the outer peripheries of the blades 7 in such a way that the upper edges visible from the direction of the rotary shaft become continually connected.

When the centrifugal fan 5 rotates at high speed in a rotating direction designated by arrow R, air is taken in from the air inlet provided at the center of the fan cover 2b so as to oppose an upper surface of the hub 6 and an air inlet provided at a bottom surface of the fan frame 2a, from a direction of the rotary shaft (not shown) of the centrifugal fan 5 to be described later. The direction of the taken in air is changed toward the centrifugal direction of the blades 7 in the fan case 2 by means of rotary movement of the plurality of blades 7. The majority of the air is fed in the same direction as the rotating direction of the centrifugal fan 5 designated by arrow R along an interior wall of the frame 2a and an interior wall of the cover 2b while colliding with the interior walls, to thus exit from the outlet port 3.

The centrifugal fan unit 1 has an un-illustrated hall element and a drive IC. The south pole and the north pole of a magnet provided in the centrifugal fan 5 are detected by the hall element, and an FG signal representing a rotational frequency and rotation timing is output from the drive IC.

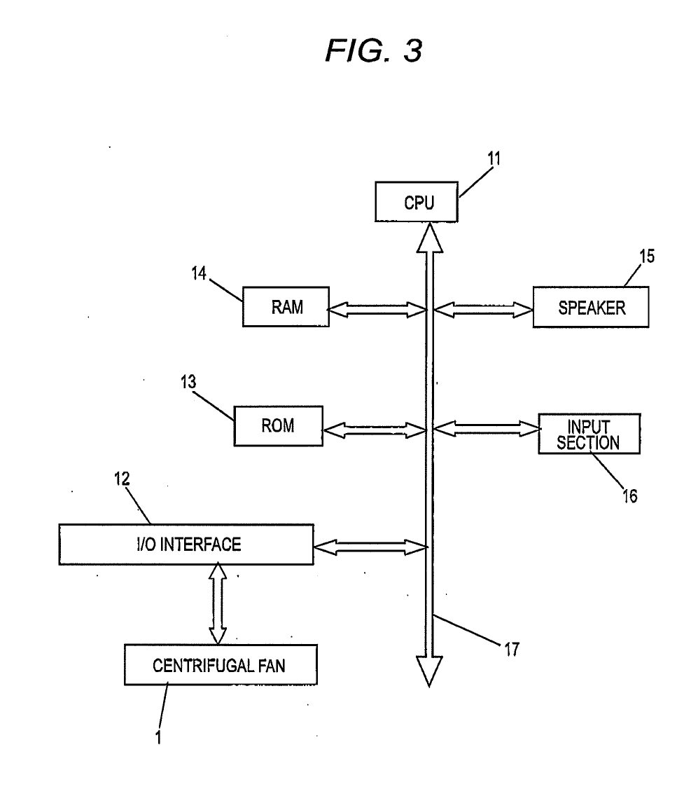

Specific means of the silencer of the present invention is now described. FIG. 3 is a hard block diagram of an electronic device equipped with the silencer of the present embodiment.

In FIG. 3, reference numeral 10 designates an electronic device, and reference numeral 1 designates a centrifugal fan for cooling the interior of the electronic device 10. The centrifugal fan unit 1 operates under control of a CPU (Central Processing Unit) 11 that is a control section and is connected to the electronic device 1 by way of an I/O interface 12. During operation, the centrifugal fan unit 1 generates predetermined noise by means of driving operation.

The electronic device 10 includes the CPU 11, ROM (Read Only Memory) 13, and RAM (Random Access Memory) 14. The CPU 11 controls the entirety of the electronic device 10. The ROM 13 has un-illustrated nonvolatile memory, or the like, that stores a control program, or the like, for controlling the electronic device 10. The RAM 14 provides a work area for the CPU 1′1. The electronic device 10 has a speaker 15 and an input section 16, and the speaker 15 outputs a signal that is in opposite phase with noise having periodicity generated by the centrifugal fan unit 1 (hereinafter called an “opposite phase waveform”). As will be described later in detail, when synchronization between noise and timing of initiation of one cycle of the opposite phase waveform is lost at an operator's position, the operator controls the timing by way of the input section 16. The CPU 11, the I/O interface 12, the ROM 13, the RAM 14, the speaker 15, and the input section 16 are connected to each other by way of a bus line 17.

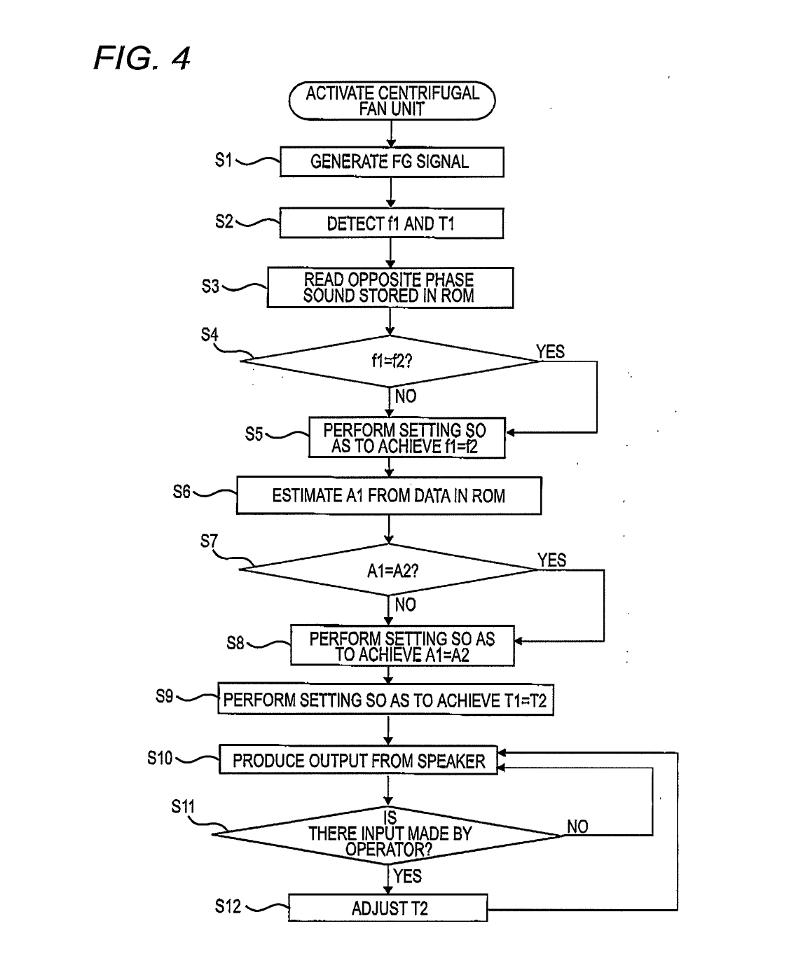

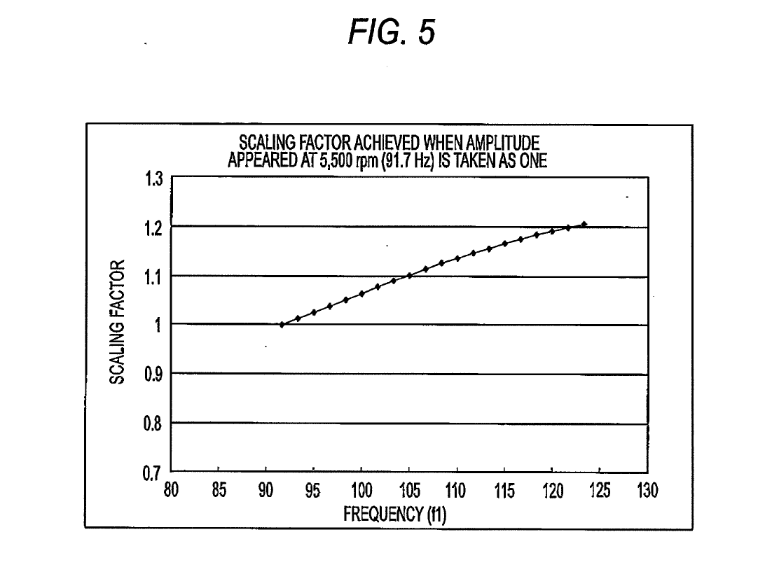

FIG. 4 is a flowchart showing operation of the CPU of the embodiment. The CPU referred to herein designates a CPU of the electronic device 10 and a CPU of the cooling fan 1. FIG. 5 is a graph showing a correlation between an amplitude and a rotational frequency of the opposite phase waveform. The correlation shown in FIG. 5 is a mere example and varies according to the type and shape of the cooling fan. The graph showing the correlation between the amplitude and the rotational frequency of the opposite phase waveform is not limited to a graph, like FIG. 5, but may also be a correspondence table, like Table 1.

TABLE 1

| | | | | | | | |
|---|---|---|---|---|---|---|---|
| AMPLITUDE | | 1 | 1.013 | 1.026 | 1.039 | 1.052 | 1.065 |
| MAGNIFICATION | | | | | | | |
| ROTATIONAL | 92.5 | 91.66667 | 93.33333 | 95 | 96.66667 | 98.33333 | 100 |
| FREQUENCY [Hz] | | | | | | | |
| NUMBER OF | 5550 | 5500 | 5600 | 5700 | 5800 | 5900 | 6000 |
| REVOLUTIONS [rpm] | | | | | | | |
| AMPLITUDE | 1.078 | 1.091 | 1.103 | 1.115 | 1.127 | 1.137 | 1.147 |
| MAGNIFICATION | | | | | | | |
| ROTATIONAL | 101.6667 | 103.3333 | 105 | 106.6667 | 108.3333 | 110 | 111.6667 |
| FREQUENCY [Hz] | | | | | | | |
| NUMBER OF | 6100 | 6200 | 6300 | 6400 | 6500 | 6600 | 6700 |
| REVOLUTIONS [rpm] | | | | | | | |
| AMPLITUDE | 1.157 | 1.167 | 1.176 | 1.185 | 1.193 | 1.2 | 1.207 |
| MAGNIFICATION | | | | | | | |
| ROTATIONAL | 113.3333 | 115 | 116.6667 | 118.3333 | 120 | 121.6667 | 123.3333 |
| FREQUENCY [Hz] | | | | | | | |
| NUMBER OF | 6800 | 6900 | 70000 | 7100 | 7200 | 7300 | 7400 |
| REVOLUTIONS [rpm] | | | | | | | |

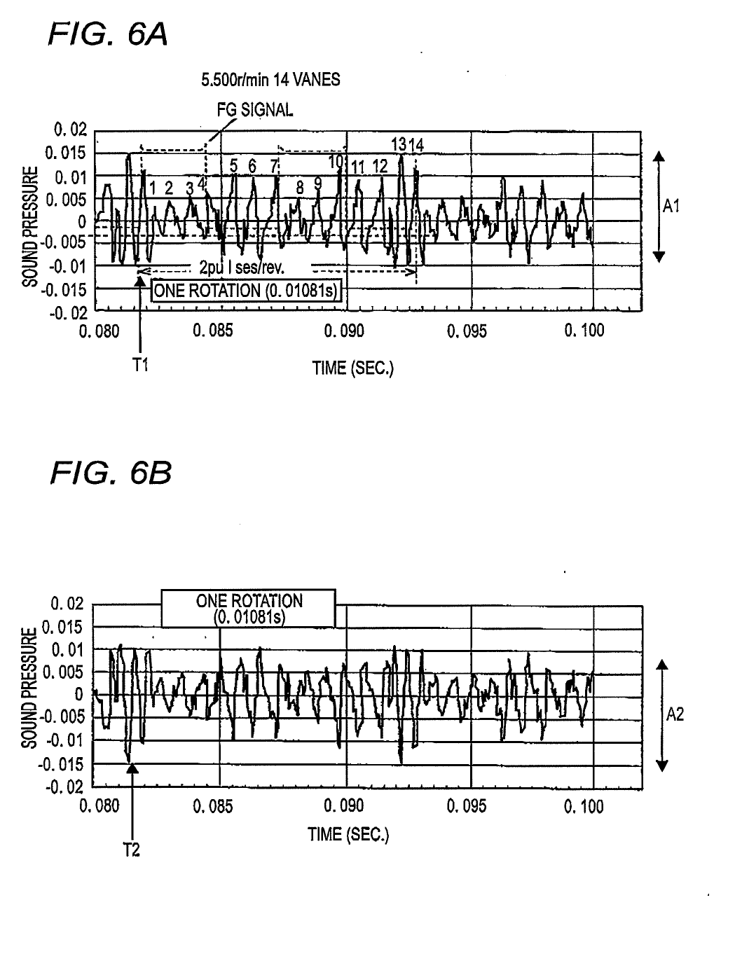

FIG. 6A is a graph showing example noise generated by the cooling fan, and FIG. 6B is a graph showing an opposite phase waveform for the noise shown in FIG. 6A.

In the following embodiment, an explanation is given by means of taking the notebook PC as an example, and the speaker 15 is embodied as a speaker built in the notebook PC. The centrifugal fan unit 1 repeatedly outputs noise generated during one rotation of the centrifugal fan unit 1 every time the fan makes one rotation, and the noise exhibits periodicity, such as that shown in FIG. 6A. The opposite phase waveform for noise generated during one rotation of the cooling fan 5, such as that shown in FIG. 6B, is previously stored in the ROM 13. An amplitude A1 representing the sound volume of noise of the centrifugal fan 5 also exhibits correlation with the rotational frequency. A table or graph showing the correlation, such as that shown in FIG. 5, can previously be stored in the ROM 13. FIG. 5 shows magnitudes of amplitudes of respective frequencies achieved when the amplitude shown in FIG. 6B is taken as one.

When rotation of the centrifugal fan 5 is started, the drive IC generates, in S1, an FG signal resultant from a signal of a sinusoidal wave, or the like, from the hall element being converted into a rectangular wave. A rotational frequency f1 of the centrifugal fan 5 and timing T1 at which one cycle of noise starts are detected in the FG signal in S2. An opposite phase waveform previously stored in the ROM 13, such as that shown in FIG. 6B, is subsequently read in S3. It is determined in S4 whether or not the rotational frequency f1 of the centrifugal fan 5 is equal to a frequency f2 at which one cycle of the opposite phase waveform is repeated. When the rotational frequency f1 is not equal to the frequency f2, processing proceeds to S5. The repetition frequency f2 of the opposite phase waveform is adjusted so as to become equal to the rotational frequency f1 of the centrifugal fan 5, and processing then proceeds to S6.

When the rotational frequency f1 of the centrifugal fan 5 is equal to the repetition frequency f2 of the opposite phase waveform in S4, processing proceeds to S6. By means of a frequency of the centrifugal fan detected in S2, an amplitude A1 of noise of the centrifugal fan 5 is estimated in S6 from data, such as a table or a graph showing correlation between the amplitude A1 of noise of the centrifugal fan 5 and the rotational frequency stored in the ROM 13, such as that shown in FIG. 5. It is determined in S7 whether or not the amplitude A1 of noise of the centrifugal fan 5 and an amplitude A2 of the opposite phase waveform are equal to each other. When the amplitudes are not equal to each other, processing proceeds to S8. The amplitude A2 of the opposite phase waveform is adjusted so as to become equal to the amplitude A1 of noise of the centrifugal fan 5, and processing proceeds to S9. Even when the amplitude A2 of the opposite phase waveform is not equal to the amplitude A1 of noise, a noise cancellation effect is yielded. Processing pertaining to S4 and S5 that are steps of making the frequency f2 of the opposite phase waveform equal to the rotational frequency f1 of the centrifugal fan 5 and processing pertaining to S6 to S8 that are steps of making the amplitude A2 of the opposite phase waveform equal to the amplitude A1 of noise of the centrifugal fan 5 may also be performed in reverse order to that employed in the embodiment and simultaneously.

In step S9, timing T2 at which one cycle of the opposite phase waveform starts is synchronized to timing T1 at which one cycle of noise of the centrifugal fan 5 detected in S2 starts. The opposite phase waveform is output from the speaker 15 in S10. The opposite phase waveform consequently cancels the noise of the centrifugal fan 5.

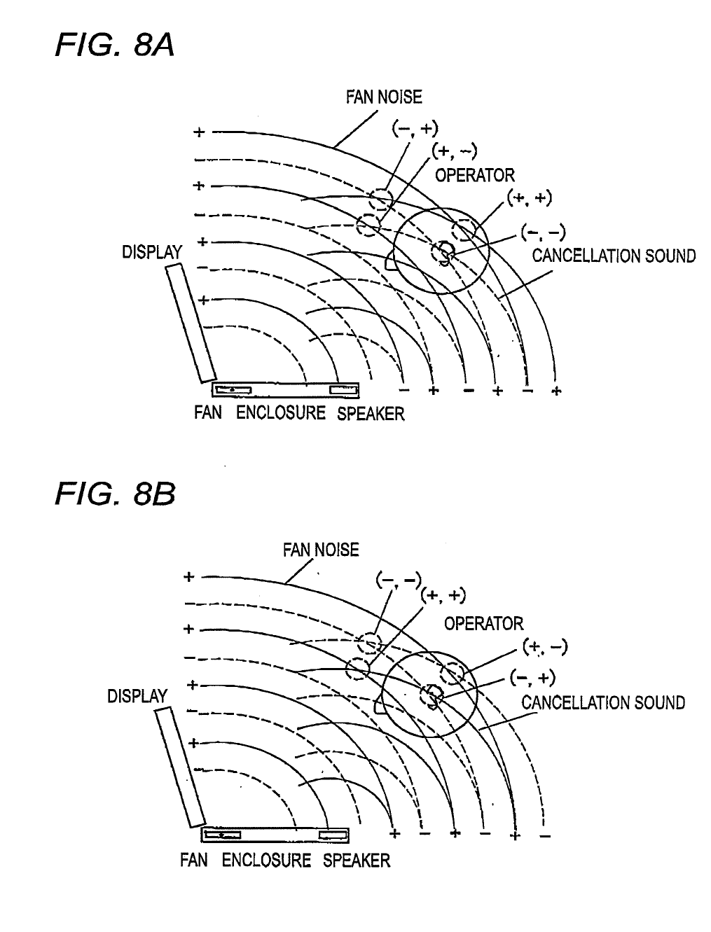

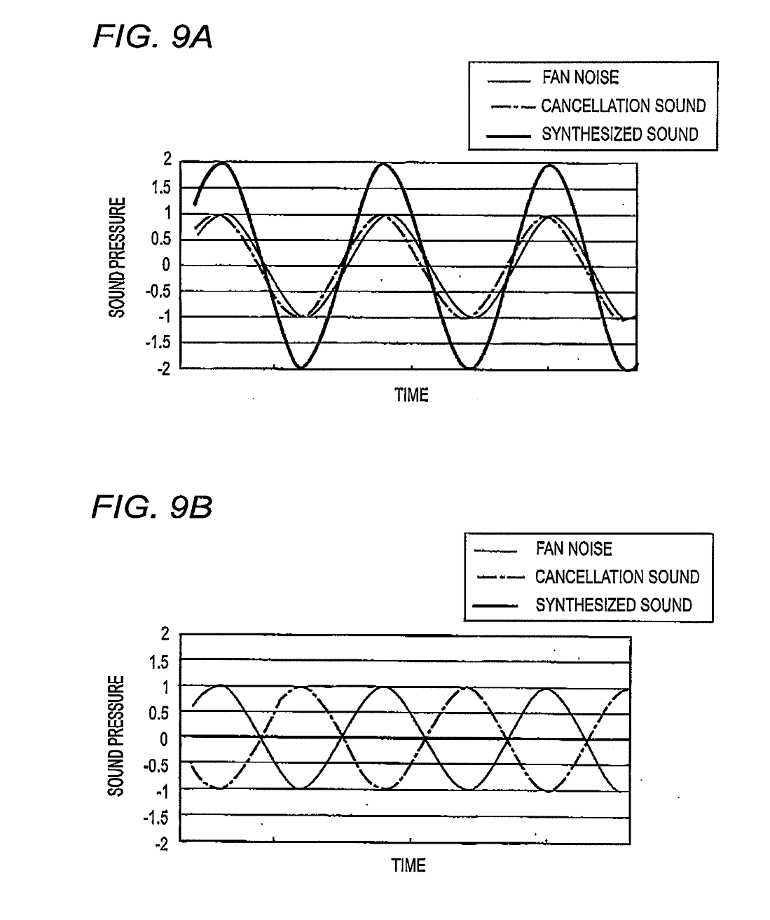

However, as will be described in detail by reference to FIGS. 8 and 9, the noise of the centrifugal fan 5 may not be cancelled well depending on the position of the operator up to S10. By way of the input section 16, the operator shifts timing 12 at which one cycle of the opposite phase waveform starts, thereby making it possible to cancel the noise of the centrifugal fan 5 well. Therefore, presence or absence of an input made by the operator is detected in S11. When the input is absent, processing returns to S10. When the input is present, the timing T2 is adjusted as instructed by the operator's input in S12, and processing returns to S10. The previously-stored opposite phase waveform varies according to the shape of the centrifugal fan 5 and exhibits periodicity as mentioned previously.

Since the opposite phase waveform is previously stored through the foregoing steps, the necessity for a microphone is obviated. Moreover, since complicate arithmetic processing is not required, a phase delay of the opposite phase waveform can be prevented. Therefore, the speaker 15 can be provided in the vicinity of the cooling fan 5, and the opposite phase waveform output from the speaker 15 can cancel the noise given off by the cooling fan 5 over a wide range. Since the opposite phase waveform for only the cooling fan 5 is previously stored, the canceller is not affected by noise other than that given off by the cooling fan 5.

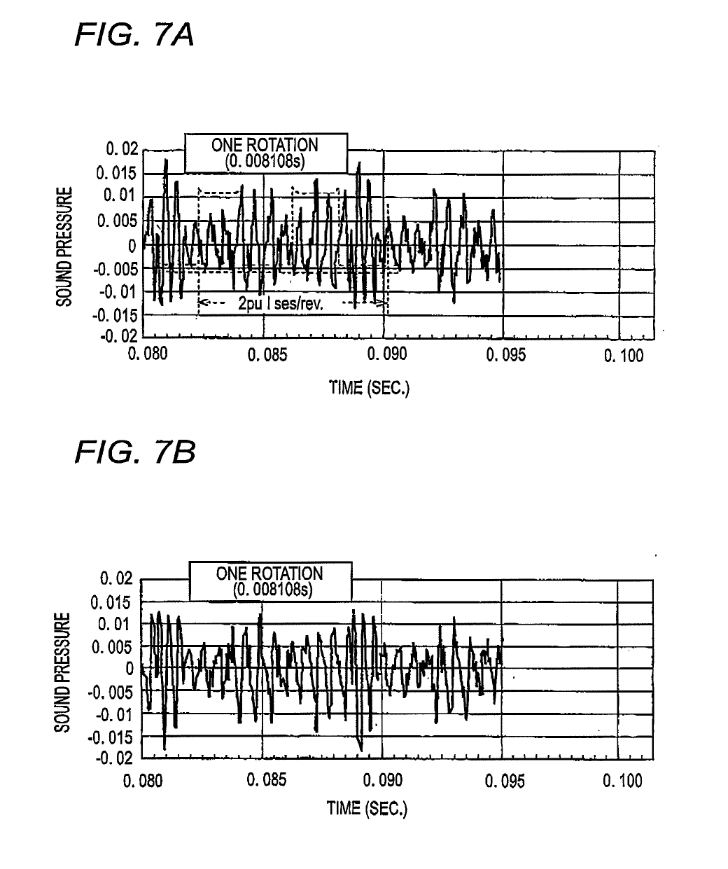

Explanations are now given to the noise of the centrifugal fan unit 1 and its opposite phase waveform by reference to a waveform showing a sound pressure level of the noise given off by the centrifugal fan unit 1 and the waveform representing the sound pressure level of the opposite phase waveform for cancelling noise. FIG. 7A is a graph showing noise achieved when the number of rotations of the centrifugal fan is larger than that shown in FIG. 6A. FIG. 7B is a graph showing an opposite phase waveform for the noise shown in FIG. 7A.

In FIG. 6, FIG. 6A is a waveform chart showing a sound pressure level of noise usually given off by the centrifugal fan, and FIG. 6B is a waveform showing a sound pressure level of the opposite phase waveform cancelling the noise shown in FIG. 6A.

Noise actually given off by the centrifugal fan is identified by detecting an FG signal shown in FIG. 6A. There is generated cancellation sound that has the same frequency and amplitude as those of noise generated by the centrifugal fan and that has a waveform in opposite phase with the noise given off by the centrifugal fan, as shown in FIG. 6B. The opposite phase waveform shown in FIG. 6B is a signal having a reversal of a positive or negative sign of noise given off by the centrifugal fan shown in FIG. 6A.

The cancellation sound shown in FIG. 6B and the noise shown in FIG. 6A are synthesized, whereby a sound pressure level of the synthesized wave comes to zero, and noise is eventually canceled.

Explanations are now given to a case where the number of revolutions of the motor is increased. FIG. 7A is a waveform chart showing a sound pressure level of noise given off by the centrifugal fan 1 when the number of revolutions becomes greater than that shown in FIG. 6A, and FIG. 7B is a waveform chart showing a sound pressure level of the opposite phase waveform cancelling the noise shown in FIG. 7A. The centrifugal fan usually rotates at speed shown in FIG. 6A. However, an object to be cooled, like the CPU 11, gives off a larger volume of heat than that generated in normal times, the number of revolutions of the centrifugal fan 5 increases. Noise from the centrifugal fan 5 assumes a waveform such as that shown in FIG. 7A at that time. A change in the rotational frequency of the centrifugal fan unit 1 is detected by means of the FG signal, whereby the frequency and amplitude of the opposite phase waveform are adjusted so as to become commensurate with a detected new rotational frequency. The previously-stored opposite phase waveform corresponding to FIG. 6B becomes as shown in FIG. 7B. The noise given off by the centrifugal fan unit 1 shown in FIG. 7A and the opposite phase waveform shown in FIG. 78 are synthesized, a sound pressure level of the synthesized wave comes to zero. Thus, even when a change has occurred in the rotational frequency of the centrifugal fan, noise is cancelled, In the present embodiment, the previously-stored opposite phase waveform is adjusted by means of the detected FG signal. However, an opposite phase waveform commensurate with the FG signal can also be stored, and the opposite phase waveform can be generated.

Explanations are now given to a phase relationship between the noise of the centrifugal fan unit 1 and the opposite phase waveform by reference to FIGS. 8A, 8B, 9A, and 9B. FIGS. 8A and 8B are conceptual renderings showing a relationship between noise and the position of the enclosure and the position of the operator, and FIGS. 9A and 9B are waveform charts of noise caught by the operator. FIGS. 8A and 9A show cases where the operator is situated in a range in which the noise of the centrifugal fan 5 is not canceled and which noise and the opposite phase waveform intensify each other. FIGS. 8B and 9B show cases where noise of the centrifugal fan is canceled by means of the operator adjusting the timing of initiation of one cycle of the opposite phase waveform, The relationship between noise and the opposite phase waveform is described by use of a sinusoidal waveform in order to make the explanations simple. In FIGS. 8A and 8B, reference symbol “+” depicts locations where the sound pressure level is positive, and reference symbol “−” depicts locations where the sound pressure level is negative. Further, the frequency of noise given off by the centrifugal fan and the frequency of the opposite phase waveform output from the speaker are assumed to be equal to each other.

In order to cancel noise of the centrifugal fan, it is necessary to cancel the noise by means of an opposite phase waveform as mentioned above. However, depending on the position of the operator who operates the notebook PC, there may be the case where the operator is situated in a range where both the sound pressure level of noise of the centrifugal fan and the sound pressure level of the opposite phase waveform assume a sign, as shown in FIG. 8A. As shown in FIG. 9A, timing of initiation of one cycle of the opposite phase waveform (cancellation sound) is shifted at this position from timing of initiation of one cycle of noise (fan noise) of the centrifugal fan 5.

The noise and the opposite phase waveform intensify each other as shown in FIG. 9A as a result of being synthesized. The same also applies to a range where both the sound pressure level of noise of the centrifugal fan 5 and the sound pressure level of the opposite phase waveform exhibit a “+” sign. In such a case, the operator adjusts the timing of initiation of one cycle of the opposite phase waveform in such a way that the sound pressure level of noise of the centrifugal fan 5 exhibits a “+” sign and that the sound pressure level of the opposite phase waveform exhibits a “−” sign at the operator's position; or such that the sound pressure level of noise of the centrifugal fan 5 exhibits a “−” sign and that the sound pressure level of the opposite phase waveform exhibits a “+” sign at the operator's position. Specifically, timing of initiation of one cycle of the opposite phase waveform is input to the timing adjustment section so as to change from FIG. 9A to FIG. 9B. As a consequence, noise of the centrifugal fan 5 and the opposite phase waveform are synthesized, to thus generate waveforms as shown in FIG. 9B. Thus, the noise is canceled.

There is a case where timing of initiation of one cycle of the opposite phase waveform cannot be adjusted for reasons of the operator being in operation. In such a case, an electronic device equipped with a centrifugal fan; for instance, a notebook personal computer, is provided with a camera, and the position of the operator is recognized by a camera. Information about the operator's position recognized by the camera is delivered to the CPU 11. The CPU 11 performs adjustment in such a way that timing of initiation of one cycle of the opposite phase waveform matches timing of initiation of one rotation of the centrifugal fan 5 at the operators position. Consequently, the opposite phase waveform can cancel the noise of the centrifugal fan 5 wherever the operator is situated.

Even when the camera is not provided, the noise of the centrifugal fan 5 can be canceled at any position and wherever the operator is situated without involvement of the operator adjusting the timing T2, so long as a distance between the centrifugal fan 5 and the speaker 15 falls within a range of 10 cm or less. As the distance between the centrifugal fan 5 and the speaker 15 is shorter, the noise of the centrifugal fan 5 can be canceled over a wider range without involvement of the operator adjusting the timing T2. The essential requirement for the silencer is to be used for noise exhibiting a periodicity and to have a speaker for cancelling noise and the centrifugal fan unit 1. The silencer can also be utilized for electronic equipment other than the notebook PC, such as a desktop PC and a TV set.

The silencer of the present invention has: a cooling fan unit that cools a component which gives off heat during operation by blowing wind to the component and that outputs signal including rotational frequency information and information about timing of initiation of one cycle of noise; a storage section that stores an opposite phase waveform for the noise given off by the cooling fan unit; and a control section that detects the signal from the cooling fan unit and that adjusts the timing of initiation of one cycle of the opposite phase waveform. The foregoing configuration obviates requirement for a microphone used for previously storing an opposite phase waveform and complicate arithmetic processing; hence, a phase lag in opposite phase waveform can be prevented. Accordingly, the speaker can be placed in proximity to the cooling fan. The opposite phase waveform output from the speaker can cancel noise given off by the cooling fan over a wide range. Since the opposite phase waveform solely for the cooling fan is previously stored, the silencer is not affected by noise other than the noise originated from the cooling fan.

The control section adjusts the frequency of the opposite phase waveform in accordance with a signal, so as to become equal to the frequency of noise given off by the cooling fan unit, thereby eliminating noise.

The control section adjusts the amplitude of the opposite phase waveform in accordance with a signal, so as to become proportional to the amplitude of noise given off by the cooling fan unit. As a result, even when the amplitude of noise differs from the amplitude of the opposite phase waveform, a phase lag in opposite phase waveform is prevented without requirement of complicate arithmetic processing, thereby eliminating noise.

Correlation between the amplitude and the rotational frequency of noise given off by the cooling fan unit is stored in the storage section. The amplitude of the opposite phase waveform is adjusted by means of the correlation. Even when the noise and the opposite phase waveform differ from each other in terms of an amplitude, adjustments can be performed such that the amplitudes are made equal to each other by means of simple processing. Hence, occurrence of a phase lag in the opposite phase waveform is prevented without a necessity for complicate arithmetic processing, whereby noise can be eliminated.

The control section has an input section that, in accordance with a signal, changes the timing of initiation of one cycle of the opposite phase waveform adjusted so as to become equal to the timing of initiation of one cycle of noise given off by the cooling fan unit. Even if an operator is situated at a position where noise cannot be eliminated well, it is possible to readily adjust timing of initiation of one cycle of the opposite phase waveform so as to become equal to timing of initiation of one cycle of noise given off by the cooling fan unit.

A silencing method of the present invention employs: a cooling fan unit that cools a component which gives off heat during operation by blowing wind to the component and that outputs signal including rotational frequency information and information about timing of initiation of one cycle of noise; a storage section that stores an opposite phase waveform for the noise given off by the cooling fan unit; and a control section that detects the signal from the cooling fan unit and that adjusts the timing of the signal and the timing of initiation of one cycle of the opposite phase waveform. The method includes detecting a signal including the rotational frequency information about the cooling fan unit and information about timing of initiation of one cycle of the noise; and adjusting the timing of initiation of one cycle of the opposite phase waveform in accordance with the information about the timing of initiation of one cycle of the noise. The foregoing configuration obviates requirement for a microphone used for previously storing an opposite phase waveform and complicate arithmetic processing; hence, a phase lag in opposite phase waveform can be prevented. Accordingly, the speaker can be placed in proximity to the cooling fan. The opposite phase waveform output from the speaker can cancel noise given off by the cooling fan over a wide range. Since the opposite phase waveform solely for the cooling fan is previously stored, the silencer is not affected by noise other than the noise originated from the cooling fan.

A signal from the cooling fan unit is detected, and the frequency and amplitude of the opposite phase waveform are then adjusted in accordance with the rotational frequency information. Timing of initiation of one cycle of the opposite phase waveform is then adjusted, so that an opposite phase waveform is readily generated without a necessity for complicate arithmetic processing. Thus, noise given off by the cooling fan can be eliminated over a wide range.

After having adjusted the timing of initiation of one cycle of the opposite phase waveform in accordance with information about timing of initiation of one cycle included in the signal, the control section changes the timing of initiation of one cycle of the opposite phase waveform in accordance with the information input to the input section. Thus, even if the operator is situated at a location where noise cannot be canceled well, timing of initiation of one cycle of the opposite phase waveform can readily be adjusted so as to become equal to the timing of initiation of one cycle of noise given off by the cooling fan unit.

Further, the control section estimates an amplitude of noise on the basis of the previously stored correlation between the amplitude of the opposite phase waveform and the rotational frequency of the cooling fan unit, thereby adjusting the amplitude of the opposite phase waveform to an optimum amplitude. Thus, even when the amplitude of noise differs from the amplitude of the opposite phase waveform, the amplitudes can readily be adjusted so as to become equal to each other through simple processing. A phase lag in the opposite phase waveform is prevented without requirement of complicate arithmetic processing, and noise can be eliminated.

As a result of the silencer being equipped with a speaker that outputs an opposite phase waveform, an opposite phase waveform output from the speaker can cancel noise given off by the cooling fan over a wide range. A camera that recognizes an operator's position who is operating an electronic device is provided, and the control section adjusts timing of initiation of one cycle of noise given off by the cooling fan unit and timing of initiation of once cycle of an opposite phase waveform at the position recognized by the camera. As a result, even when timing of initiation of one cycle of an opposite phase waveform cannot be adjusted for reasons of the operator being in operation, the timing of initiation of one cycle of the opposite phase waveform can readily be adjusted so as to become equal to timing of initiation of one cycle of noise given off by the cooling fan unit when the operator is situated at a location where noise cannot be eliminated well.

Information about the position recognized by the camera is output to the control section, and the control section adjusts timing of initiation of once cycle of an opposite phase waveform in accordance with the positional information. As a result, even when timing of initiation of one cycle of an opposite phase waveform cannot be adjusted for reasons of the operator being in operation, the timing of initiation of one cycle of the opposite phase waveform can readily be adjusted so as to become equal to timing of initiation of one cycle of noise given off by the cooling fan unit when the operator is situated at a location where noise cannot be eliminated well.

Even when the silencer of the present invention is built in a miniaturized electronic device, a phase lag does not arise in an opposite phase waveform, and noise given off by a centrifugal fan can be eliminated over a wide range. Further, the silencer is not affected by noise other than that originated from the centrifugal fan; hence, the silencer is useful for an electronic device, such as a personal computer.

This application claims the benefit of Japanese Patent application No. 2009-32191 filed on Jan. 30, 2009, the entire contents of which are incorporated herein by reference.

1. A silencer comprising:
a cooling fan unit that cools a component which gives off heat during operation by blowing wind to the component and that outputs signal including rotational frequency information about the cooling fan and information about timing of initiation of one cycle of noise;
a storage section that stores an opposite phase waveform for the noise given off by the cooling fan unit; and
a control section that detects the signal from the cooling fan unit and that adjusts the timing of initiation of one cycle of the opposite phase waveform.

2. The silencer according to claim 1, wherein, in accordance with the signal, the control section adjusts a frequency of the opposite phase waveform so as to become equal to a frequency of noise given off by the cooling fan unit.

3. The silencer according to claim 1, wherein, in accordance with the signal, the control section adjusts an amplitude of the opposite phase waveform so as to become proportional to an amplitude of noise given off by the cooling fan unit.

4. The silencer according to claim 3, wherein the control section stores correlation between an amplitude and a rotational frequency of noise of the cooling fan unit in the storage section and adjusts the amplitude of the opposite phase waveform by means of the correlation.

5. The silencer according to claim 1, wherein the control section has an input section for changing timing of initiation of one cycle of the opposite phase waveform adjusted, in accordance with the signal, so as to become equal to the timing of initiation of one cycle of noise given off by the cooling fan unit.

6. A silencing method using a cooling fan unit that cools a component which gives off heat during operation by blowing wind to the component and that outputs signal including rotational frequency information and information about timing of initiation of one cycle of noise; a storage section that stores an opposite phase waveform for the noise given off by the cooling fan unit; and a control section that detects the signal from the cooling fan unit and that adjusts timing of the signal and the timing of initiation of one cycle of the opposite phase waveform, the method comprising:
detecting a signal including the rotational frequency information about the cooling fan unit and information about timing of initiation of one cycle of the noise; and
adjusting the timing of initiation of one cycle of the opposite phase waveform in accordance with the information about timing of initiation of one cycle of the noise.

7. The silencing method according to claim 6, further comprising:
detecting the signal from the cooling fan unit;
adjusting a frequency and an amplitude of the opposite phase waveform in accordance with the rotational frequency information; and
adjusting timing of initiation of one cycle of the opposite phase waveform.

8. The silencing method according to claim 6, wherein, after having adjusting timing of initiation of one cycle of the opposite phase waveform in accordance with the information about timing of initiation of one cycle of the noise including in the signal, the control section changes timing of initiation of one cycle of the opposite phase waveform in accordance with the information input to the input section.

9. The silencing method according to claim 6, wherein the control section estimates an amplitude of the opposite phase waveform in accordance with a previously stored correlation between the amplitude of the opposite phase waveform and the rotational frequency of the cooling fan unit and adjusts the amplitude of the opposite phase waveform to an optimum amplitude.

10. The silencer according to claim 1, further comprising a speaker that outputs the opposite phase waveform.

11. The silencer according to claim 1, further comprising:
a camera that recognizes position of an operator who is using the electronic equipment, wherein
the control section adjusts the timing of initiation of one cycle of noise given off by the cooling fan unit and timing of initiation of one cycle of the opposite phase waveform according to a position recognized by the camera.

12. The silencer according to claim 11, wherein information about the position recognized by the camera is output to the control section, and the control section adjusts timing of initiation of one cycle of the opposite phase waveform in accordance with the positional information.
